(19) United States
(12) Patent Application Publication
(10) Pub. No.: US 2023/0019528 A1
(43) Pub. Date: Jan. 19, 2023

(54) LIQUID CIRCUIT FOR AN AGRICULTURAL SPRAYER COMPRISING A SEALED TRANSFER SYSTEM AND A DOSING MECHANISM

(71) Applicant: EXEL INDUSTRIES, Epernay (FR)

(72) Inventor: Sylvain Pitaud, Paris (FR)

(73) Assignee: EXEL INDUSTRIES, Epernay (FR)

(21) Appl. No.: 17/812,566

(22) Filed: Jul. 14, 2022

(30) Foreign Application Priority Data
Jul. 16, 2021 (FR) 2107706

(51) Int. Cl. A01C 23/00; A01C 23/04

(52) U.S. Cl. CPC A01C 23/008; A01C 23/04; A01C 23/007

(57) ABSTRACT

The invention relates to a liquid circuit for an agricultural sprayer having a main tank, a sealed transfer system able to transfer a liquid product contained in a drum to the liquid circuit in a sealed manner, a suction mechanism designed to suck the liquid product coming from the sealed transfer system and to discharge said liquid product to the main tank, a dosing mechanism and a control unit designed to determine a quantity of liquid product to be provided to the suction mechanism for the filling of the main tank, and to control the dosing mechanism to provide the determined quantity of liquid product to the suction mechanism, in such a way as to meter the liquid product transferred from the sealed transfer system to the main tank.

### TECHNICAL FIELD

The invention relates to a liquid circuit for an agricultural sprayer, an agricultural sprayer for an agricultural machine comprising such a liquid circuit and an agricultural machine comprising such an agricultural sprayer.

### BACKGROUND

Sealed transfer systems for an agricultural sprayer, in particular called “Closed Transfer System” or “CTS” are known from the prior art.

Such sealed transfer systems are provided to transfer liquid product from a drum to a main tank of the agricultural sprayer in a sealed manner. For this, the drum is often placed upside down, the spout of said drum being directed downwards and cooperating with the sealed transfer system in order to provide the sealed transfer of liquid product from the drum to the main tank. During the transfer, the liquid product is often incorporated into clear water, in such a way as to form a processing liquid to be sprayed on plants to be treated of a field.

However, according to the quantity of liquid product to be transferred from the drum to the main tank, it may occur that the drum is not to be completely emptied and therefore that only a portion of the liquid product contained in the drum is to be transferred to the main tank. A dosing of the liquid product transferred from the drum to the main tank is then required.

In order to provide this dosing, a farmer may for example manually open a valve of the sealed transfer system in order to authorize a transfer of the liquid product from the drum to the main tank until in light of the remaining quantity of liquid product in the drum, it seems to the farmer that the quantity of liquid product transferred from the drum to the main tank corresponds approximately to the desired quantity and they close the valve of the sealed transfer system.

Such a dosing is therefore not precise, which may lead to over-dosing just like to under-dosing of the processing liquid as a liquid product. The case of over-dosing is not acceptable from an environmental standpoint. In the case of under-dosing, the effectiveness of the processing liquid sprayed on the plants to be treated of the field is necessarily reduced, which may lead to a drop in yield of the field and therefore is not acceptable for the farmer.

There is therefore a need to provide a precise dosing during a transfer of liquid product from a drum to a main tank by means of a sealed transfer system.

### SUMMARY OF THE INVENTION

To this effect, the invention has for purpose a liquid circuit for an agricultural sprayer comprising:
a main tank,
a sealed transfer system able to transfer a liquid product contained in a drum to the liquid circuit in a sealed manner,
a suction mechanism designed to suck the liquid product coming from the sealed transfer system and to discharge said liquid product to the main tank,
a dosing mechanism arranged downstream from the sealed transfer system and upstream from the suction mechanism,
a control unit designed to determine a quantity of liquid product to be provided to the suction mechanism for the filling of the main tank, and to control the dosing mechanism to provide the determined quantity of liquid product to the suction mechanism, in such a way as to meter the liquid product transferred from the sealed transfer system to the main tank.

According to embodiment that may be taken together or separately:
the dosing mechanism comprises a displacement pump arranged downstream from the sealed transfer system and upstream from the suction mechanism;
the displacement pump is a gear or lobe pump, or a variable displacement, swash plate or bent-axis axial piston pump, or a peristaltic pump, or a single rotary piston valveless pump or a piston pump with valve;
the control unit is designed to determine, from the determined quantity of processing liquid and a displacement of the displacement pump, a number of revolutions to be carried out by the displacement pump, and to control the expeller pump to rotate the determined number of revolutions;
the liquid circuit comprises a diversion channel arranged parallel to the displacement pump, between the sealed transfer system and the suction mechanism, and designed to authorize the liquid product coming from the sealed transfer system to bypass the displacement pump for the suction thereof by the suction mechanism, when the diversion channel is open;
the control unit is designed to control the displacement pump to rotate at a higher rotation speed during a suction phase and at a lower rotation speed during a discharge phase of each cycle of the displacement pump, the variation in the rotation speed between the suction and discharge phase being progressive;
the dosing mechanism comprises a dosing valve designed to open and close and a flowmeter arranged upstream or downstream from the dosing valve and upstream from the suction mechanism and designed to measure a flow rate of liquid product flowing from the dosing valve to the suction mechanism, the control unit being designed to determine, from the flow rate measured by the flowmeter and from the determined quantity of liquid product, a remaining quantity of liquid product to be provided to the suction mechanism for the filling of the main tank, and to control the dosing valve to close when the determined remaining quantity of liquid product is zero;
the liquid circuit comprises a rinsing tank configured to contain a rinsing liquid and a rinsing channel connecting the rinsing tank to a rinsing device of the sealed transfer system able to rinse the drum and comprising a rinsing pump designed to suck the rinsing liquid coming from the rinsing tank and to discharge it to the rinsing device.

The invention further relates to an agricultural sprayer for an agricultural machine comprising a liquid circuit such as described hereinabove.

The invention also relates to an agricultural machine comprising an agricultural sprayer such as described hereinabove, wherein the sealed transfer system is onboard the agricultural machine.

### BRIEF DESCRIPTION OF THE DRAWINGS

Other aspects, buts, advantages and characteristics of the invention shall appear better when reading the following detailed description of preferred embodiments of the latter, given by way of a non-limiting example, and given in reference to the accompanying drawing wherein:

FIG. 1 is a diagrammatical view of an agricultural sprayer comprising a liquid circuit according to an embodiment of the invention.

### DETAILED DESCRIPTION

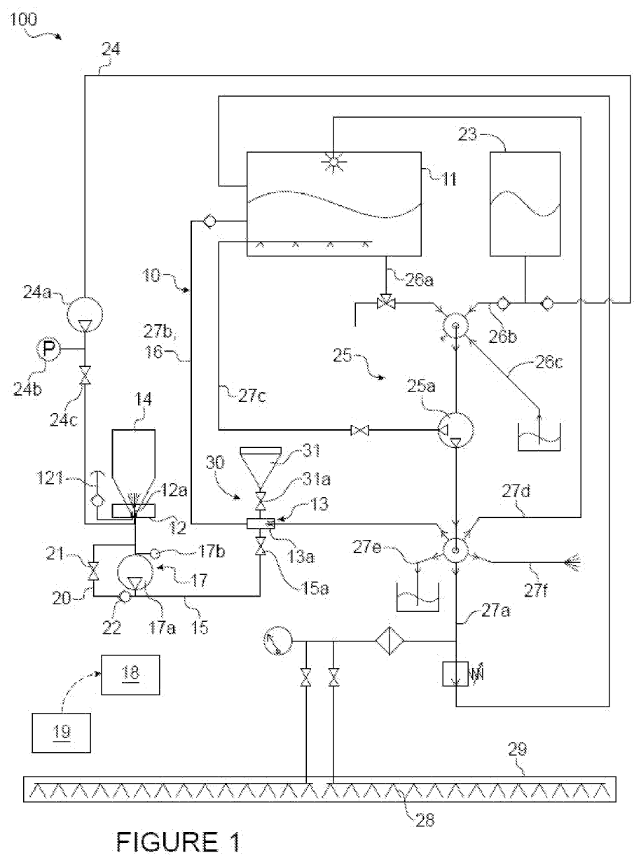

FIG. 1 shows an agricultural sprayer 100 for an agricultural machine, the agricultural sprayer 100 being configured to spray a processing liquid in a field of plants to be treated, for example large crops, such as the culture of cereals, and comprising a liquid circuit 10 according to an embodiment of the invention.

The agricultural sprayer 100 is for example in contact with a ground, in particular the field of plants to be treated, for example via wheels (not shown) allowing for the displacement thereof.

The agricultural sprayer 100 is for example configured to be towed by the agricultural machine, such as a tractor. Alternatively, the agricultural sprayer 100 is configured to be borne by the agricultural machine. Again alternatively, the agricultural sprayer 100 is self-propelled and therefore forms the agricultural machine.

An orthogonal reference system is adopted in a non-limiting way comprising a longitudinal direction towards the front on the forward direction of the agricultural machine, a transversal direction towards the left and a vertical direction upwards. The longitudinal and transversal directions are horizontal, globally parallel to the ground.

The liquid circuit 10 comprises a main tank 11 configured to contain a processing liquid, such as a mixture of clear water and phytosanitary product, also called “spray liquid”, a sealed transfer system 12 and a suction mechanism 13.

The sealed transfer system 12 is able to transfer a liquid product contained in a drum 14, such as phytosanitary product, to the liquid circuit 10 in a sealed manner. The sealed transfer system 12 is also called “Closed Transfer System” or “CTS”. The sealed transfer system 12 is in particular compliant with standard ISO 21191 published on 26 Feb. 2021. The sealed transfer system 12 is in particular able to put into communication the drum with the liquid circuit 10, when the drum is connected in a sealed manner to the sealed transfer system 12.

The drum 14 comprises for example a spout (not referenced) provided to be connected in a sealed manner with the sealed transfer system 12. For this, sealed and reversible means of connection between the spout of the drum 14 and the sealed transfer system 12 are provided. When the spout of the drum 14 and the sealed transfer system 12 are connected in a sealed manner to one another, the drum 14 is for example turned over, its spout being directed downwards, in such a way that the liquid product contained in the drum 14 is poured into the sealed transfer system 12 and therefore in the liquid circuit 10 in particular via gravity.

The sealed transfer system 12 may further comprise a rinsing device 12a able to rinse the inside of the drum 14 with a rinsing liquid, such as clear water, in particular when the spout of the drum 14 cooperates in a sealed manner with the sealed transfer system 12. During the rinsing of the drum 14, the rinsing liquid is removed by the sealed transfer system 12 to the liquid circuit 10 in the same way as the liquid product.

The sealed transfer system 12 is for example onboard an agricultural machine.

The suction mechanism 13 is designed to suck the liquid product coming from the sealed transfer system 12, in particular via a transfer channel 15, and to discharge the sucked liquid product to the main tank 11, in particular via an incorporation line 16. As shall be explained in detail hereinafter, the liquid product is in particular incorporated into clear water or pre-spray liquid when it is discharged to the main tank 11, in such a way as to form the processing liquid to be sprayed on the plants to be treated of the field.

In the rest of the description, the terms “upstream” and “downstream” take account of the direction of circulation of the liquid in the liquid circuit 10, which is imposed by the suction mechanism 13.

The liquid circuit 10 further comprises a dosing mechanism 17, as well as an electronic control unit 18.

The dosing mechanism 17 is arranged downstream from the sealed transfer system 12 and upstream from the suction mechanism 13, in particular along the transfer channel 15.

The control unit 18 is designed to determine a quantity of liquid product to be provided to the suction mechanism 13 for the filling of the main tank 11, and to control the dosing mechanism 17 to provide the determined quantity of liquid product to the suction mechanism 13.

The dosing mechanism 17 and the control unit 18 thus make it possible to carry out a precise dosing of the liquid product coming from the sealed transfer system 12, thus preventing the risks linked to an over-dosing or an under-dosing of the processing liquid as liquid product.

The quantity of liquid product to be provided to the suction mechanism 13 for the filling of the main tank 11 is for example determined from predefined parameters such as a volume of the main tank 11, a surface of the field of plants to be treated, a volume of liquid product to be used per surface unit, and/or a quantity of liquid product already transferred to the main tank 11.

The treatment parameters are for example pre-recorded in a data memory of the control unit 18. One, several or all the treatment parameters may otherwise be recorded by a farmer in the data memory of the control unit 18, via a user interface 19.

The dosing mechanism 17 comprises for example a displacement pump 17a arranged downstream from the sealed transfer system 12 and upstream from the suction mechanism 13, in particular along the transfer channel 15. The transfer of liquid product in the displacement pump 17a is done by means of several members, which are driven in rotation by a motor, in particular by means of a rotating shaft, and which drive a volume of liquid product in displacement at each one of the rotations thereof. The motor is driven by the control unit 18. The motor may be directly driven by the control unit 18, when the motor is electrical, or indirectly when the motor is hydraulic, the control unit 18 driving a hydraulic circuit which itself drives the motor. Each cycle of the displacement pump 17a comprises a suction phase during which the displacement pump 17a such a volume of liquid product and a discharge phase during which the displacement pump 17a discharges the volume of liquid product. Each cycle corresponds to one or several revolutions of the shaft of the motor and therefore to a rotation of the members driven in rotation by the motor. At each cycle, the displacement pump 17a therefore delivers a defined volume of liquid product, and therefore a defined quantity of liquid product, thus making it possible to meter the liquid product coming from the sealed transfer system 12 for the filling of the main tank 11.

The motor of the displacement pump 17a is for example a stepping motor or a servomotor, in such a way as to provide precise control of the motor and therefore of the displacement pump 17a as a number of revolutions and/or as rotation speed. A precise control of the displacement pump 17a makes it possible to further improve the precision of the dosing of liquid product coming from the sealed transfer system 12.

The expeller pump 17a may be a gear or lobe pump, a variable displacement, in particular swash plate or bent-axis, axial piston pump, a peristaltic pump or a single rotary piston valveless pump. Such expeller pumps 17a have the advantage of not depending on or of depending very little on the viscosity of the liquid product that passes through them. Thus, regardless of the liquid product contained in the drum 14 and its viscosity, the displacement pump 17a is capable of delivering the same quantity of liquid product for the same volume. This makes it possible to increase the precision of the dosing carried out by means of the displacement pump 17a.

Gear or lobe pumps, peristaltic and variable displacement, swash plate or bent-axis axial piston pumps, are well known to those skilled in the art. They will not be described in detail here.

The term “single rotary piston valveless pump” means a pump such as for example described in documents U.S. Pat. Nos. 4,941,809 A and 5,246,354 B1.

Such a pump comprises in particular a motor provided with a shaft rotating about a motor axis, a piston housed in a cylinder and a movement converter member.

The piston extends along a piston axis, secant or confounded with the motor axis, and comprises a first end provided with a radial piece with respect to the piston axis and a second opposite end with respect to the piston axis and provided with a flat. The piston and the cylinder are furthermore integrally mounted pivoting with respect to the motor, about a pivot axis perpendicular to the motor axis and to the piston axis. The piston axis is thus able to be inclined with respect to the motor axis in a plane perpendicular to the pivot axis.

The movement converter member comprises a bottom integral in rotation with the shaft of the motor and a side wall extending, from the bottom, about the axis of the motor. The radial piece of the piston cooperates with a ball knob housed in the side wall of the movement converter member. The movement converter member is thus capable of driving in rotation the piston about the piston axis. The ball knob further authorizes the piston and the cylinder to pivot with respect to the motor about the pivot axis.

In this way, when the shaft of the motor rotates about the axis of the motor, it drives in rotation the movement converter member, which itself drives in rotation the piston due to the cooperation between the radial piece of the piston and of the ball knob of the movement converter member. Moreover, according to the angle formed between the motor axis and the axis of the piston, and therefore according to the inclination of the piston with respect to the shaft of the motor, the movement converter member drives or not the piston sliding in the cylinder along the piston axis. In particular, when the motor axis and the axis of the piston are confounded, there is no sliding of the piston in the cylinder. The travel of the piston in the cylinder is therefore variable and such a pump is a variable displacement pump, the displacement varying according to the angle between the motor axis and the piston axis.

The cylinder further comprises at least two openings among which at least one inlet and at least one outlet. For example, the cylinder comprises an inlet and an outlet that are diametrically opposite with respect to the piston axis. The openings communicate with the housing of the cylinder wherein the piston is provided to slide. The flat of the piston is furthermore designed to authorize the inlet of fluid in the housing of the cylinder and to block the outlet of fluid from said housing, when the first end of the piston moves away from the cylinder (suction phase), to block the inlet and the outlet of fluid from the housing of the cylinder, when the first end of the piston is farthest from the cylinder, to block in the inlet of fluid in the housing of the cylinder and authorize the outlet of fluid from said housing, when the first end of the piston approaches the cylinder (discharge phase), and to block the inlet and the outlet of fluid from the housing of the cylinder, when the first end of the piston is closest to the cylinder. This operation however applies only to a defined range of angles between the motor axis and the piston axis, referred to as operating range. The zero angle is of course excluded from this range since at this angle the piston does not slide in the cylinder. Moreover, when the angle between the motor axis and the piston axis is greater than this range, the piston is no longer capable of obstructing the openings of the housing of the cylinder, in such a way that they communicate together, via the housing of the cylinder. The assembly of the ball knob in the movement converter member also constrains the operating range. The flat of the piston may of course be replaced with a groove or with any other form able to provide the operation described hereinabove.

For example, for the cleaning of the pump, the movement converter member is rotated about the motor axis in such a way as to position the radial piece of the piston substantially parallel to the pivot axis. The term “substantially parallel to the pivot axis” means that at a zero angle between the motor axis and the piston axis, the radial piece of the piston is parallel to the pivot axis. In this position of the radial piece of the piston, the ball knob indeed authorizes an angle between the motor axis and the piston axis greater than the operating range. The piston and the cylinder may then be pivoted in such a way that the angle between the motor axis and the piston axis is greater than the operating range and the openings of the housing of the cylinder communicate together. The pump may then be stopped for the cleaning thereof, which facilitates this. Sensors, such as an indexing sensor on the motor shaft and a reset sensor, may be provided to authorize the controlling of the pump beyond this range for the cleaning thereof and in order to ensure its return within the range for the dosing of liquid product.

The control unit 18 is designed to determine, from the determined quantity of liquid product and from a displacement of the displacement pump 17a, a number of revolutions to be carried out by the displacement pump 17a, in particular by the shaft of the motor of the displacement pump 17a, and to control the displacement pump 17a to rotate the determined number of revolutions. As indicated hereinabove, a precise driving of the displacement pump 17a makes it possible to improve the precision of the dosing of liquid product coming from the sealed transfer system 12.

The displacement of the displacement pump 17a is for example pre-recorded in the data memory of the control unit 18. The displacement of the displacement pump 17a may also be recorded by the farmer in the data memory of the control unit 18, via the user interface 19. In the case of a variable displacement pump 17a, the control unit 18 may be designed to determine the displacement of the displacement pump 17a at an instant t, and to determine, from the displacement of the displacement pump 17a at the instant t, the number of revolutions to be carried out by the displacement pump 17a.

The control unit 18 may also be designed to control the displacement pump 17a, in particular the shaft of the motor, to rotate at a higher rotation speed during the suction phase and at a lower rotation speed during the discharge phase of each cycle of the displacement pump 17a. The variation in the rotation speed between the suction phase and the discharge phase is furthermore progressive. In this way, at each cycle, the suction phase of the displacement pump 17a is shorter than its discharge phase. Moreover, as the variation in the rotation speed is progressive, this makes it possible to prevent jerks and therefore to limit the pulses that may be produced by the displacement pumps 17a due to its suction and discharge phases and which may result in variations in the quantity of liquid product exiting from the displacement pump 17a. The rotation speeds during the suction and discharge phases of the displacement pump 17a are for example determined in such a way that the suction phase lasts 25% of one cycle of the displacement pump 17a and that the discharge phase lasts 75% of one cycle of the displacement pump 17a. The expeller pump 17a may further be provided with an air bell (not shown) or air accumulator in order to limit the pulses of said expeller pump 17a.

The direction of rotation of the displacement pump 17a, in particular of the shaft of the motor, may be reversible. The expeller pump 17a is for example able to rotate in a first direction of rotation in order to discharge liquid product to the suction mechanism 13, and to rotate in a second opposite direction of rotation to discharge liquid product to the sealed transfer system 12 and the drum 14. When the displacement pump 17a rotates in the second direction of rotation, it is possible to discharge liquid product removed from the drum 14 in addition, in particular liquid product located in the dead volumes of the sealed transfer system 12 and of the transfer channel 15 between the sealed transfer system 12 and the inlet of the displacement pump 17a. The expeller pump 17a may be supplied with clear water for the discharging of liquid product to the sealed transfer system 12 and the drum 14 by the displacement pump 17a in the second direction of rotation. The control unit 18 is for example designed to control the displacement pump 17a to rotate in the first or in the second direction of rotation. Unless explicitly mentioned, when it is described that the displacement pump 17a rotates, the displacement pump 17a rotates in the first direction of rotation. Likewise, unless explicitly mentioned, the suction and the discharging of the displacement pump 17a correspond to the suctions and the discharging of the displacement pump 17a rotating in the first direction of rotation. These dead volumes may also be pre-calculated and taken into consideration during the determining of the number of revolutions to be carried out by the displacement pump 17a.

The dosing mechanism 17 comprises for example one or more detectors of the presence of liquid 17b designed to detect the presence of liquid at the inlet of the displacement pump 17a and to send a liquid detection signal to the control unit 18, when the detector or detectors of the presence of liquid 17b detect liquid at the inlet of the displacement pump 17a. The control unit 18 is designed to receive the detection signal from the detector or detectors of the presence of liquid 17b and to control the displacement pump 17a to rotate the determined number of revolutions starting from the reception of the detection signal. In this way, the dosing of liquid product begins only once liquid product has reached the displacement pump 17a, which makes it possible to overcome dead volumes of the sealed transfer system 12 and of the transfer channel 15 between the sealed transfer system 12 and the inlet of the displacement pump 17a, and therefore to improve the precision of the dosing. Alternatively, these dead volumes are pre-calculated and taken into consideration during the determining of the number of revolutions to be carried out by the displacement pump 17a.

The liquid circuit 10 may further comprise a diversion channel 20 arranged parallel to the displacement pump 17a, between the sealed transfer system 12 and the suction mechanism 13. The diversion channel 20 is thus connected to the sealed transfer system 12 upstream from the displacement pump 17a and to the suction mechanism 13 downstream from the displacement pump 17a. The diversion channel 20 is furthermore designed to authorize the liquid product coming from the sealed transfer system 12 to bypass the displacement pump 17a for the suction thereof by the suction mechanism 13, and therefore to short-circuit the displacement pump 17a, when the diversion channel 20 is open. The diversion channel 20 thus makes it possible to overcome the dosing of liquid product transferred to the main tank 11, when such dosing is for example not required. This may be the case when the drum 14 must be completely emptied.

For this, the diversion channel 20 comprises for example a bypass valve 21 designed to open and close. The diversion channel 20 may also comprise a non-return valve 22 designed to prevent processing liquid circulating along the diversion channel 20 to discharge to the sealed transfer system 12.

The control unit 18 is for example designed to control the diversion channel 20, in particular the bypass valve 21, to open, when the control unit 18 receives an instruction to not meter processing liquid coming from the sealed transfer system 12, and to close, when the control unit 18 receives an instruction to meter processing liquid coming from the sealed transfer system 12. The instruction to meter or not to meter the processing liquid coming from the sealed transfer system 12 may be sent by the user interface 19. The farmer for example sends to the control unit 18 the instruction to not meter the processing liquid coming from the sealed transfer system 12, when the drum 14 has to be completely emptied.

The transfer channel 15 may further comprise a first cut-off valve 15a arranged downstream from the displacement pump 17a and where applicable, from the diversion channel 20. The first cut-off valve 15a is in particular designed to open and to close the connection between the transfer channel 15 and the incorporation line 16, in such a way as to authorized or prevent the transfer of liquid product of the sealed transfer system 12 to the main tank 11, via the suction mechanism 13 and the incorporation line 16. The first cut-off valve 15a may be controlled manually or by the control unit 18.

As an alternative (not shown) of the displacement pump 17a, the dosing mechanism 17 comprises a dosing valve arranged upstream from the suction mechanism 13 and designed to open and close, as well as a flowmeter arranged upstream or downstream from the dosing valve and upstream from the suction mechanism 13. The flowmeter is designed to measure a flow rate of liquid product flowing to the suction mechanism 13, in particular along the transfer channel 15. The control unit 18 is then designed to determine, from the flow rate measured by the flowmeter and from the determined quantity of liquid product, a remaining quantity of liquid product to be provided to the suction mechanism 13 for the filling of the main tank 11, and to control the dosing valve to close when the determined remaining quantity of liquid product is zero. The dosing valve may be a valve incorporated into the sealed transfer system 12 or a valve separate from the sealed transfer system 12 and arranged downstream from the sealed transfer system 12 along the transfer channel 15.

The liquid circuit 10 may also comprise a rinsing tank 23 configured to contain rinsing liquid, such as clear water, and a rinsing channel 24 connecting the rinsing tank 23 to the rinsing device 12a of the sealed transfer system 12 and comprising a rinsing pump 24a designed to suck the rinsing liquid coming from the rinsing tank 23 and to discharge it to the rinsing device 12a of the sealed transfer system 12. The rinsing pump 24a is for example a piston diaphragm pump.

In the rest of the description, the terms “upstream” and “downstream” take account of the direction of circulation of the liquid in the liquid circuit 10, which is imposed by the rinsing pump 24a.

A pressure sensor 24b may further be provided downstream from or integrated into the rinsing pump 24a. The pressure sensor 24b is designed to measure a pressure of the rinsing liquid circulating along the rinsing channel 24. The control unit 18 or a control unit integrated into the rinsing pump 24a is for example designed to control the rinsing pump 24a to stop, when the pressure measured by the pressure sensor 24b is greater than or equal to a threshold pressure, and to control the rinsing pump 24a to operate, when the pressure measured by the pressure sensor 24b is strictly less than the threshold pressure. This thus makes it possible to ensure that the pression downstream from the rinsing pump 24a is greater than or equal to the threshold pressure. The threshold pressure is for example pre-recorded in the data memory of the control unit 18 or of the control unit integrated into the rinsing pump 24a. The threshold pressure may otherwise be recorded by the farmer in the data memory of the control unit 18 or of the control unit integrated into the rinsing pump 24a, via the user interface 19 or a user interface dedicated to the rinsing pump 24a.

A rinsing valve 24c may also be provided along the rinsing channel 24, in particular downstream from the rinsing pump 24a. The rinsing valve 24c is designed to open and close the rinsing channel 24, in such a way as to authorize or prevent rinsing liquid from supplying the rinsing device 12a of the sealed transfer system 12. The rinsing valve 24a may be controlled manually or by the control unit 18.

The rinsing channel 24 may also comprise a non-return valve (not referenced), in particular arranged upstream from the rinsing pump 24a, in such a way as to prevent a return of rinsing liquid to the rinsing tank 23.

The sealed transfer system 12 may also be equipped with a vent 121 that communicates on the one hand with the outside air and on the other hand with the inside of the drum 14, when the drum 14 is connected in a sealed manner to the sealed transfer system 12. The vent 121 makes it possible to incorporate air inside the drum 14 so as to prevent any deformations or any crushing of the latter during the emptying thereof. The vent 121 may furthermore be equipped with a non-return valve (not referenced) designed to prevent liquid product coming from the drum 14 from escaping through the vent 121.

The liquid circuit 10 also comprises for example a pumping assembly 25, supply lines 26a, 26b, 26c and discharge lines 27a, 27b, 27c, 27d, 27e, 27f of which the incorporation line 16 is a part of.

The pumping assembly 25 comprises a main pump 25a itself comprising an inlet through which the main pump 25a sucks a liquid and at least one outlet through which the main pump 25a discharges the liquid sucked through the inlet.

In the rest of the description, the terms “upstream” and “downstream” take account of the direction of circulation of the liquid in the liquid circuit 10, which is imposed by the main pump 25a.

The suction lines 26a, 26b, 26c are each connected, downstream, to the inlet of the main pump 25a. The suction lines 26a, 26b, 26c are thus arranged upstream from the main pump 25a. The main pump 25a may thus suck liquid in each one of the suction lines 26a, 26b, 26c in order to discharge it. The suction lines 26a, 26b, 26c are parallel to one another.

One 26a of the suction lines 26a, 26b, 26c, referred to main tank suction line, connects the main tank 11 to the inlet of the main pump 25a. The main pump 25a may thus suck processing liquid coming from the main tank 11 in order to discharge it.

Another 26b of the suction lines 26a, 26b, 26c, referred to as rinsing suction line, connects the rinsing tank 23 to the main pump 25a. The main pump 25a may then suck clear water coming from the rinsing tank 23 to rinse or clean the liquid circuit 10. The rinsing suction line 26b comprises for example a common segment with the rinsing channel 24. A non-return valve (not referenced) may further be provided along the rinsing suction line 26b, in particular downstream from the common segment with the rinsing channel 24, in such a way as to prevent a return of liquid to the rinsing tank 23.

Another 26c of the suction lines 26a, 26b, 26c, referred to as external suction line, is for example configured to be connected to a source of liquid external to the agricultural sprayer 100. For this, the external suction line 26c may comprise a hydraulic inlet connector configured to be reversibly connected to the source of liquid external to the agricultural sprayer 100. The main pump 25a may then suck liquid external to the agricultural sprayer 100.

The discharge lines 27a, 27b, 27c, 27d, 27e, 27f are each connected, upstream, to the or one of the outlets of the main pump 25a. The discharge lines 27a, 27b, 27c, 27d, 27e, 27f are thus arranged downstream from the main pump 25a. The main pump 25a may thus discharge liquid in each one of the discharge lines 27a, 27b, 27c, 27d, 27e, 27f. The discharge lines 27a, 27b, 27c, 27d, 27e, 27f are parallel together.

One 27a at least of the discharge lines 27a, 27b, 27c, 27d, 27e, 27f, referred to as spraying line, comprises spraying nozzles 28 mounted on a sprayer boom 29 of the agricultural sprayer 100 and designed to spray liquid on the plants to be treated of the field. When the main pump 25a sucks processing liquid from the main tank 11 and this sucked processing liquid is discharged into the spraying line or lines 27a, the spraying nozzles 28 spray processing liquid from the main tank 11. The sprayer boom 29 extends for example along a main horizontal direction of extension, in particular globally transversal.

As indicated hereinabove, another 27b of the second discharge lines 27a, 27b, 27c, 27d, 27e, 27f, is the incorporation line 16. The incorporation line 16 connects the or one of the outlets of the main pump 25a to the main tank 11. The incorporation line 16 comprises for example an incorporation assembly 30 designed to incorporate a product to be incorporated into the liquid discharged by the main pump 25a and circulating along said incorporation line 16. In this way, the main tank 11 may be filled with liquid discharged by the main pump 25a into which the product to be incorporated has been incorporated. The liquid discharged by the main pump 25a may be clear water coming from the rinsing tank 23 via the rinsing suction line 26b or, via the hydraulic inlet connector and via the external suction line 26c, a source of clear water external to the agricultural sprayer 100. The liquid discharged by the main pump 25a may also be the pre-spray liquid coming from the main tank 11 via the main tank 26a suction line, the pre-spray liquid being a mixture of clear water and of product to be incorporated already realized by one or several passages though the incorporation line 16.

For this, the incorporation assembly 30 comprises in particular the suction mechanism 13. The suction mechanism 13 comprises for example a Venturi effect device 13a designed to create a depression that sucks the product to be incorporated, when liquid discharged by the main pump 25a circulates along the incorporation line 16 through the Venturi effect device 13a. In this way, the product to be incorporated, which is sucked by the Venturi effect device 13a, is incorporated into the liquid circulating along the incorporation line 16 through said Venturi effect device 13a to fill the main tank 11 with liquid to which the product to be incorporated has been incorporated.

The incorporation line 16 may further comprise a non-return valve (not referenced) arranged downstream from the suction mechanism 13, in particular from the Venturi effect device 13a, and designed to prevent the liquid into which has been incorporated the product to be incorporated and circulating along the incorporation line 16 to discharge to the suction mechanism 13. This makes it possible in particular to prevent the main tank 11 from being emptied by the incorporation line 16, to the suction mechanism 13 and therefore to the transfer system 12 and/or to the incorporation device 31 which is described hereinafter, in particular when the first and/or the second cut-off valve 15a, 31a are open.

The product to be incorporated may be liquid product coming from the sealed transfer system 12. The depression created by the Venturi effect device 13a then sucks the liquid product coming from the sealed transfer system 12 via the transfer channel 15 which is connected to the Venturi effect device 13, in particular when the first cut-off valve 15a is open.

The product to be incorporated may also be a liquid product or powdery product or product in the form of grains coming from an incorporation device 31 of the incorporation assembly 30, such as a hopper, that is connected to the Venturi effect device 13a. A second cut-off valve 31a may be provided between the incorporation device 31 and the Venturi effect device 13a. The second cut-off valve 31a is in particular designed to open and to close the connection between the incorporation device 31 and the Venturi effect device 13a, in such a way as to authorize or prevent the transfer of liquid or powdery product or product in the form of grains from the incorporation device 31 to the main tank 11, via the incorporation line 16. The depression created by the Venturi effect device 13a then sucks the liquid or powdery product or product in the form of grains coming from the incorporation device 31, when the second cut-off valve 31a is open. The second cut-off valve 31a may be controlled manually or by the control unit 18.

The control unit 18 is for example designed to prohibit the opening of the first cut-off valve 15a, when the second cut-off valve 31a is open, and to prohibit the opening of the second cut-off valve 31a, when the first cut-off valve 31a is open. Thus, the first and the second cut-off valves 15a, 13a may not be open at the same time and the incorporation line 16 may not be simultaneously supplied with product to be incorporated from the transfer channel 15 and from the incorporation device 31. Alternatively, in particular when the first and second cut-off valves 15a, 31a are manually controlled, a mechanical foolproof system is provided between the first and second cut-off valves 15a, 31a in such a way as to prevent the simultaneous opening thereof.

Another 27c of the discharge lines 27a, 27b, 27c, 27d, 27e, 27f, referred to as mixing line, connects for example the or one of the outlets of the main pump 25a to the main tank 11. The mixing line 27c opens into in particular at the lower portion of said main tank 11, in such a way as to be immersed in the processing liquid contained in the main tank 11. The mixing line 27c may comprise a restriction or at least one mixing nozzle (not referenced) arranged in the main tank 11, in particular in the lower portion of the main tank 11, in such a way as to be immersed in the processing liquid contained in the main tank 11. The mixing line 27c may thus send the liquid discharged by the main pump 25a to the main tank 11, in such a way as to stir, mix or blend the processing liquid contained in the main tank 11. The liquid discharged by the main pump 25a may be processing liquid coming from the suction line of the main tank 26a.

Another 27d of the discharge lines 27a, 27b, 27c, 27d, 27e, 27f, referred to as main tank rinsing line, comprises for example at least one rinsing nozzle (not referenced) arranged inside the main tank 11, in particular in the upper portion of said main tank 11. The rinsing nozzle or nozzles are furthermore designed to spray the liquid discharged by the main pump 25a inside the main tank 11, in particular on walls of said main tank 11. The liquid discharged by the main pump 25a may be clear water coming from the rinsing tank 23. In this way, the rinsing nozzle or nozzles make it possible to rinse the main tank 11.

Another 27e of the discharge lines 27a, 27b, 27c, 27d, 27e, 27f, referred to as external discharge line, comprises for example a hydraulic outlet connector configured to be reversibly connected to a tank external to the agricultural sprayer 100, in such a way as to transfer the liquid discharged by the main pump 25a to said external tank.

Another 27f of the discharge lines 27a, 27b, 27c, 27d, 27e, 27f, referred to as external washing line, comprises for example an external washing device, such as a hydraulic gun, in such a way as to wash the exterior of the agricultural sprayer 100 with the liquid discharged by the main pump 25a. The liquid discharged by the main pump 25a may be clear water coming from the rinsing tank 23 or, via the hydraulic inlet connector of the external suction line 26c, a source of clear water external to the agricultural sprayer 100.

The pumping assembly 25 is designed to, on the one hand, selectively put into communication one of the suction lines 26a, 26b, 26c with the inlet of the main pump 25a, and on the other hand, selectively put into communication the or at least one of the outlets of the main pump 25a with one of the discharge lines or with discharges lines 27a, 27b, 27c, 27d, 27e, 27f. The pumping assembly 25 thus makes it possible to put into communication, via the main pump 25a, the suction lines 26a, 26b, 26c with the discharge lines 27a, 27b, 27c, 27d, 27e, 27f. To this effect and such as is shown in FIG. 1, the pumping assembly 25 may comprise, upstream from the main pump 25a, a multi-channel supply valve (not referenced), and, downstream from the main pump 25a, a multi-channel distribution valve (not referenced). Alternatively, the pumping assembly 25 may comprise, upstream from the main pump 25a, a supply collector and, downstream from the main pump 25a, a distribution collector. The pumping assembly 25 is for example driven by the control unit 18.

The liquid circuit 10 described hereinabove is particularly advantageous because it makes it possible to ensure a precise dosing of the liquid product coming from the sealed transfer system 12 for the filling of the main tank 11.

1. A liquid circuit for an agricultural sprayer comprising:
a main tank,
a sealed transfer system able to transfer a liquid product contained in a drum to the liquid circuit in a sealed manner,
a suction mechanism designed to suck the liquid product coming from the sealed transfer system and to discharge said liquid product to the main tank,
the liquid circuit wherein it further comprises:
a dosing mechanism arranged downstream from the sealed transfer system and upstream from the suction mechanism,
a control unit designed to determine a quantity of liquid product to be provided to the suction mechanism for the filling of the main tank, and to control the dosing mechanism to provide the determined quantity of liquid product to the suction mechanism, in such a way as to meter the liquid product transferred from the sealed transfer system to the main tank.

2. The liquid circuit according to claim 1, wherein the dosing mechanism comprises a displacement pump arranged downstream from the sealed transfer system and upstream from the suction mechanism.

3. The liquid circuit according to claim 2, wherein the displacement pump is:
a gear or lobe pump, or
a variable displacement, swash plate or bent-axis axial piston pump, or
a peristaltic pump, or
a single rotary piston valveless pump, or
a piston pump with valve.

4. The liquid circuit according to claim 2, wherein the control unit is designed to determine, from the determined quantity of processing liquid and a displacement of the displacement pump, a number of revolutions to be carried out by the displacement pump, and to control the expeller pump to rotate the determined number of revolutions.

5. The liquid circuit according to claim 2, comprising a diversion channel arranged parallel to the displacement pump, between the sealed transfer system and the suction mechanism, and designed to authorize the liquid product coming from the sealed transfer system to bypass the displacement pump for the suction thereof by the suction mechanism, when the diversion channel is open.

6. The liquid circuit according to claim 2, wherein the control unit is designed to control the displacement pump to rotate at a higher rotation speed during a suction phase and at a lower rotation speed during a discharge phase of each cycle of the displacement pump, the variation in the rotation speed between the suction and discharge phase being progressive.

7. The liquid circuit according to claim 1, wherein the dosing mechanism comprises a dosing valve designed to open and close and a flowmeter arranged upstream or downstream from the dosing valve and upstream from the suction mechanism and designed to measure a flow rate of liquid product flowing from the dosing valve to the suction mechanism, the control unit being designed to determine, from the flow rate measured by the flowmeter and from the determined quantity of liquid product, a remaining quantity of liquid product to be provided to the suction mechanism for the filling of the main tank, and to control the dosing valve to close when the determined remaining quantity of liquid product is zero.

8. The liquid circuit according to claim 1, comprising a rinsing tank configured to contain a rinsing liquid and a rinsing channel connecting the rinsing tank to a rinsing device of the sealed transfer system able to rinse the drum and comprising a rinsing pump designed to suck the rinsing liquid coming from the rinsing tank and to discharge it to the rinsing device.

9. An agricultural sprayer for an agricultural machine comprising the liquid circuit according to claim 1.

10. The agricultural machine comprising an agricultural sprayer according to claim 9, wherein the sealed transfer system is onboard the agricultural machine.
